(19) United States
(12) Patent Application Publication
(10) Pub. No.: US 2011/0311194 A1
(43) Pub. Date: Dec. 22, 2011

(54) RECORDING CONTROL APPARATUS AND RECORDING CONTROL METHOD

(75) Inventor: Ansley Yeo, Tokyo (JP)

(73) Assignee: TOSHIBA CORPORATION, TOKYO (JP)

(21) Appl. No.: 13/161,200

(22) Filed: Jun. 15, 2011

(30) Foreign Application Priority Data
Jun. 17, 2010 (JP) 2010138589

(51) Int. Cl. H04N 9/80; H04N 5/775

(52) U.S. Cl. 386/230; 386/248; 386/249; 386/E09.011; 386/E05.07

(57) ABSTRACT

According to one embodiment, a recording control apparatus includes an output controller, a watching state detector, and a recording controller. The output controller is configured to execute control to output first content data corresponding to a first channel according to selection of the first channel and to execute control to output second content data corresponding to a second channel instead of the first content data according to a channel change from the first channel to the second channel. The watching state detector is configured to detect a watching state of the first channel. The recording controller is configured to execute control to record the first content data based on a result of detection of the watching state and the channel change.

### CROSS-REFERENCE TO RELATED APPLICATIONS

This application is based upon and claims the benefit of priority from Japanese Patent Application No. 2010-138589, filed Jun. 17, 2010; the entire contents of which are incorporated herein by reference.

### FIELD

Embodiments described herein relate generally to a recording control apparatus and a recording control method for controlling recording of programs.

### BACKGROUND

Television broadcast receiving apparatuses have been prevailing which can receive digital television broadcast signals and record and reproduce programs based on the received digital television broadcast signals. For example, television broadcast receiving apparatuses can record programs based on digital television broadcast signals using recording media such as HDDs or DVDs.

Moreover, in recent years, there has been developed a television broadcast receiving apparatuses having a plurality of tuners. Such a television broadcast receiving apparatus can simultaneously record a plurality of programs corresponding to a plurality of channels and received by the plurality of tuners. The television broadcast receiving apparatus can also reproduce a selected one of the plurality of recorded programs.

The advent of such a television broadcast receiving apparatus as described above has enabled many programs to be watched. However, there has been a demand to further improve the watching environment.

For example, when commercials are broadcast during watching of a desired program, this program may be switched to a different program, which is then watched. However, while the different program is being watched, an important scene of the desired program may be missed. For example, a technique has been proposed which allows a return to the desired program when the commercials end while the different program is being watched. However, an important scene of the desired program may be missed depending on the time to return to the desired program.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an example of the configuration of a digital television broadcast receiving apparatus (recording control apparatus) that is common to a first embodiment to a third embodiment;

FIG. 2 is a flowchart showing an example of first recording and reproduction control and second recording and reproduction control;

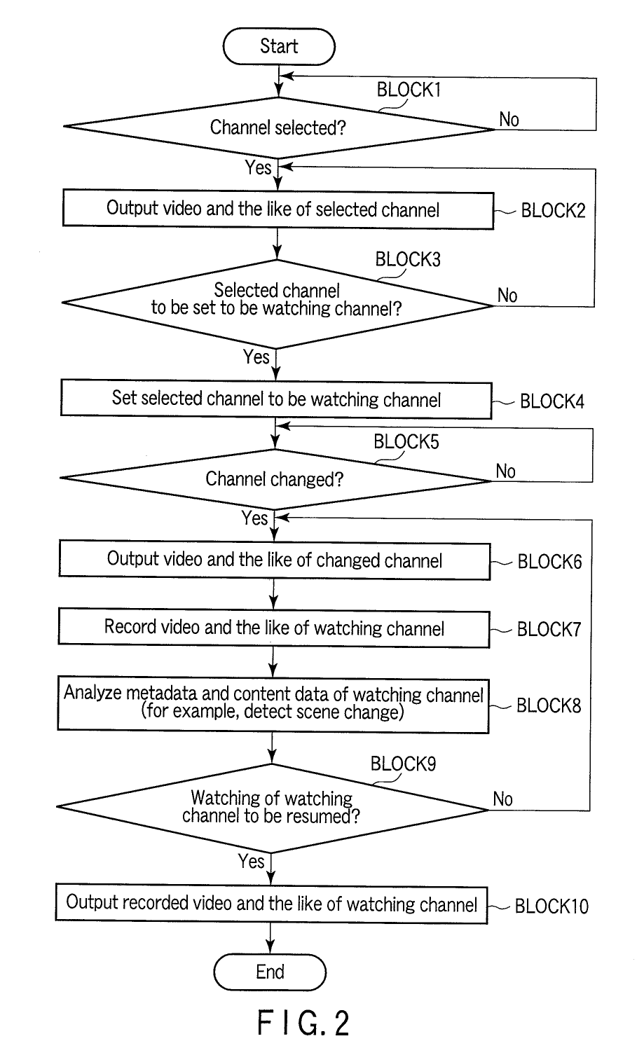

FIG. 3 is a timing chart showing an example of the first recording and reproduction control;

FIG. 4 is a timing chart showing an example of the second recording and reproduction control; and

FIG. 5 is a timing chart showing an example of third recording and reproduction control.

### DETAILED DESCRIPTION

Various embodiments will be described hereinafter with reference to the accompanying drawings.

In general, according to one embodiment, a recording control apparatus includes an output controller, a watching state detector, and a recording controller. The output controller is configured to execute control to output first content data corresponding to a first channel according to selection of the first channel and to execute control to output second content data corresponding to a second channel instead of the first content data according to a channel change from the first channel to the second channel. The watching state detector is configured to detect a watching state of the first channel. The recording controller is configured to execute control to record the first content data based on a result of detection of the watching state and the channel change.

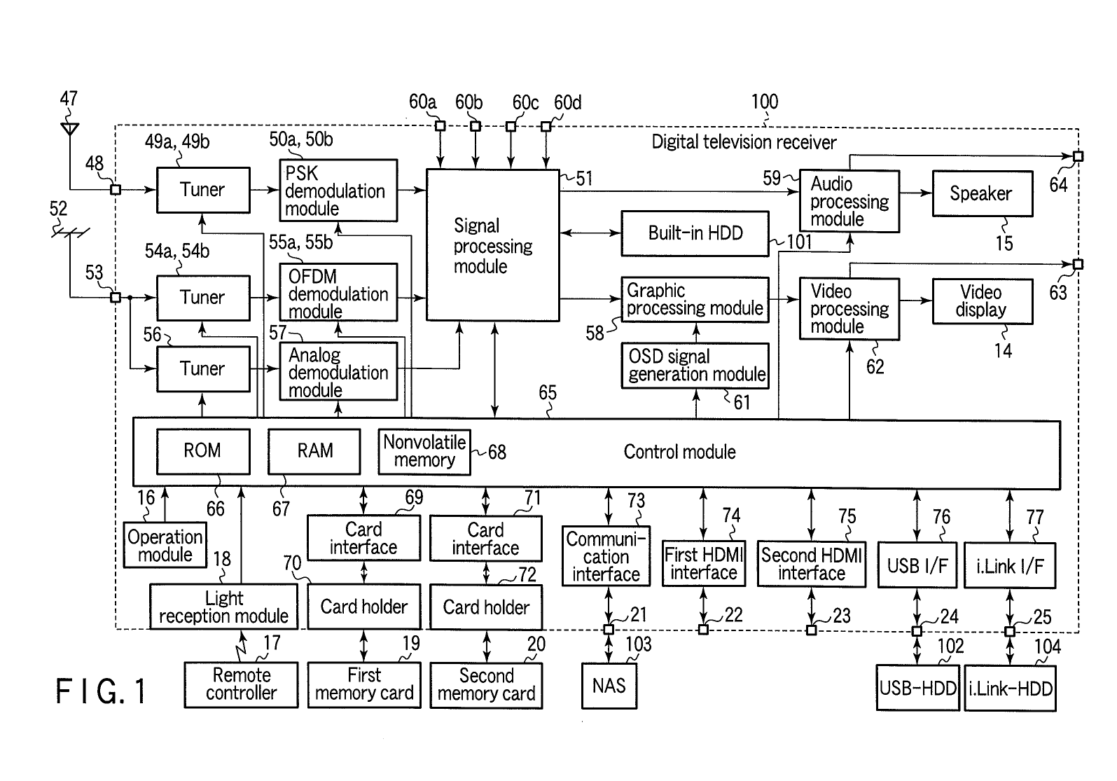

FIG. 1 is a diagram showing an example of the configuration of a digital television broadcast receiving apparatus (recording control apparatus) that is common to the first to third embodiments. In the first to third embodiments, recording and reproduction control performed by the digital television broadcast receiving apparatus will be described. However, the embodiments are not limited to the recording and reproduction control performed by the digital television broadcast receiving apparatus. The recording and reproduction control described below can be implemented by, for example, a program recording apparatus such as an HDD recorder, a Blu-ray (BD) (registered trademark) recorder, or a DVD recorder. The digital television broadcast receiving apparatus comprises a video display configured to be capable of displaying programs. In contrast, the program recording apparatus comprises a video information output section configured to output video information and the like to the video display. Hence, when the video display of the digital television broadcast receiving apparatus, which will be described below, is replaced with the video information output section, the recording and reproduction control described below can be implemented by the program recording apparatus.

A digital television broadcast receiving apparatus 100 will be described with reference to FIG. 1. As shown in FIG. 1, satellite digital television broadcast signals received by an antenna 47 for reception of BS/CS digital broadcasting are supplied to satellite digital broadcasting tuners 49a and 49b via an input terminal 48. The tuners 49a and 49b then select one of the broadcast signals which corresponds to a specified channel. The satellite digital broadcasting tuners 49a and 49b allow the digital television broadcast receiving apparatus 100 to simultaneously select satellite digital broadcast signals for up to two channels. The case where the digital television broadcast receiving apparatus 100 comprises the two satellite digital broadcasting tuners as shown in FIG. 1 will be described. However, the digital television broadcast receiving apparatus 100 may comprise at least three satellite digital broadcasting tuners.

The broadcast signal selected by the tuners 49a and 49h is supplied to phase-shift keying (PSK) demodulation modules 50a and 50b. The PSK demodulation modules 50a and 50b demodulates the broadcast signal into a digital video signal and a digital audio signal and then outputs the signals to a signal processing module 51.

Furthermore, terrestrial digital television broadcast signals received by an antenna 52 for reception of terrestrial broadcasting are supplied to terrestrial digital broadcasting tuners 54a and 54b via an input terminal 53. The tuners 54a and 54b select a broadcast signal for a specified channel. The terrestrial digital broadcasting tuners 54a and 54b allow the digital television broadcast receiving apparatus 100 to simultaneously select terrestrial digital broadcast signals for up to two channels. The case where the digital television broadcast receiving apparatus 100 comprises the two terrestrial digital broadcasting tuners as shown in FIG. 1 will be described. However, the digital television broadcast receiving apparatus 100 may comprise at least three terrestrial digital broadcasting tuners.

The broadcast signal selected by the tuners 54a and 34b is supplied to an orthogonal frequency division multiplexing (OFDM) demodulation module 55. The OFDM demodulation module 55 demodulates the broadcast signal into a digital video signal and a digital audio signal and then outputs the signals to the signal processing module 51.

Furthermore, terrestrial analog television broadcast signals received by the antenna 52 for reception of terrestrial broadcasting are supplied to a terrestrial analog broadcasting tuner 56 via the input terminal 53. The tuner 56 selects a broadcast signal for a specified channel. The broadcast signal selected by the tuner 56 is supplied to an analog demodulation module 57. The analog demodulation module 57 demodulates the broadcast signal into an analog video signal and an analog audio signal and then outputs the signals to the signal processing module 51.

Here, the signal processing module 51 selectively carries out predetermined digital signal processing on the digital video and audio signals supplied by the PSK demodulation module 50 and the OFDM demodulation module 55. The signal processing module 51 then outputs the processed signals to a graphic processing module 58 and an audio processing module 59.

Furthermore, the signal processing module 51 connects to a plurality of (in the drawings, four) input terminals 60a, 60b, 60c, and 60d. The input terminals 60a to 60d can receive analog video and audio signals transmitted from outside the digital television broadcast receiving apparatus 100.

The signal processing module 51 selectively digitizes the analog video and audio signals supplied by the analog demodulation module 57 and the input terminals 60a to 60d. The signal processing module 51 carries out predetermined digital signal processing on the digitized video and audio signals. The signal processing module 51 then outputs the processed signals to the graphic processing module 58 and the audio processing module 59.

The graphic processing module 58 provides a function to superimpose an on-screen display (OSD) signal generated by an OSD signal generation module 61 on the digital video signal supplied by the signal processing module 51 and then to output the resultant signal. The graphic processing module 58 selectively outputs the output video signal from the signal processing module 51, the output OSD signal from the OSD signal generation module 61, or a combination of both outputs.

The digital video signal output by the graphic processing module 58 is supplied to the video processing module 62. The video signal processed by the video processing module 62 is supplied to the video display 14 and also to the output terminal 63. The video display 14 displays a video based on the video signal. When external equipment is connected to the output terminal 63, the video signal supplied to the output terminal 63 is input to the external equipment.

Furthermore, the audio processing module 59 converts the input digital audio signal into an analog audio signal that can be reproduced by the speaker 15. The audio processing module 59 then outputs the analog audio signal to the speaker 15 for audio output and transmits the analog audio signal to external equipment via an output terminal 64.

The control module 65 of the digital television receiver 100 integrally controls all of the processing and operation including the above-described signal processing. The control module 65 comprises a central processing unit (CPU). Based on operation information transmitted by the remote controller 17 and received via a light reception section 18, the control module 65 controls each module so as to reflect the nature of the operation in the control.

In this case, the control module 65 mainly utilizes read-only memory (ROM) 66 configured to store control programs executed by CPU, random access memory (RAM) 67 configured to provide a work area, and a nonvolatile memory 68 configured to store various types of setting information, control information, and the like.

Furthermore, the control module 65 is connected via a card interface 69 to a card holder 70 in which a first memory card 19 can be installed. Thus, the control module 65 can transmit and receive information, via the card interface 69, to and from the first memory card 19 installed in the card holder 70.

Additionally, the control module 65 is connected via a card interface 71 to a card holder 72 in which a second memory card 19 can be installed. Thus the control module 65 can transmit and receive information, via the card interface 71, to and from the second memory card 20 installed in the card holder 72.

In addition, the control module 65 is connected to a LAN terminal 21 via a communication interface 73. Thus, the control module 65 can transmit and receive information to and from LAN-compatible equipment connected to the LAN terminal 21 via the communication interface 73. In this case, the control module 65 provides a Dynamic Host Configuration Protocol (DHCP) server function and assigns an Internet Protocol (IP) address to the LAN-compatible equipment connected to the LAN terminal 21 to control the LAN-compatible equipment. The LAN-compatible equipment may be, for example, network-attached storage (NAS) 103.

Moreover, the control module 65 is connected to a first HDMI terminal 22 via a first HDMI interface 74. Thus, the control module 65 transmits and receives information to and from HDMI-compatible equipment connected to the first HDMI terminal 22, via the first HDMI interface 74. Furthermore, the control module 65 is connected to a second HDMI terminal 23 via a second HDMI interface 75. Thus, the control module 65 transmits and receives information to and from HDMI-compatible equipment connected to the second HDMI terminal 23, via the second HDMI interface 75.

The control module 65 is connected to the USB terminal 24 via USE interface 76. Thus, the control module 65 can transmit and receive information to and from USB-compatible equipment connected to the USB terminal 24, via USE interface 76. The USE-compatible equipment may be, for example, USB-HDD 102.

Moreover, the control module 65 is connected to an i.Link terminal 25 via an i.Link interface 77. Thus, the control module 65 can transmit and receive information to and from an i.Link-compatible equipment connected to the i.Link terminal 25, via the i.Link interface 77. The i.Link-compatible equipment may be, for example, i.Link-HDD 104.

Moreover, the control module 65 references programmed recording information contained in a programmed recording list stored in the nonvolatile memory 68 to control a recording operation. A recording destination may be, for example, a built-in HDD 101, USE-HDD 102, NAS 103, and i.LINK-HDD 104.

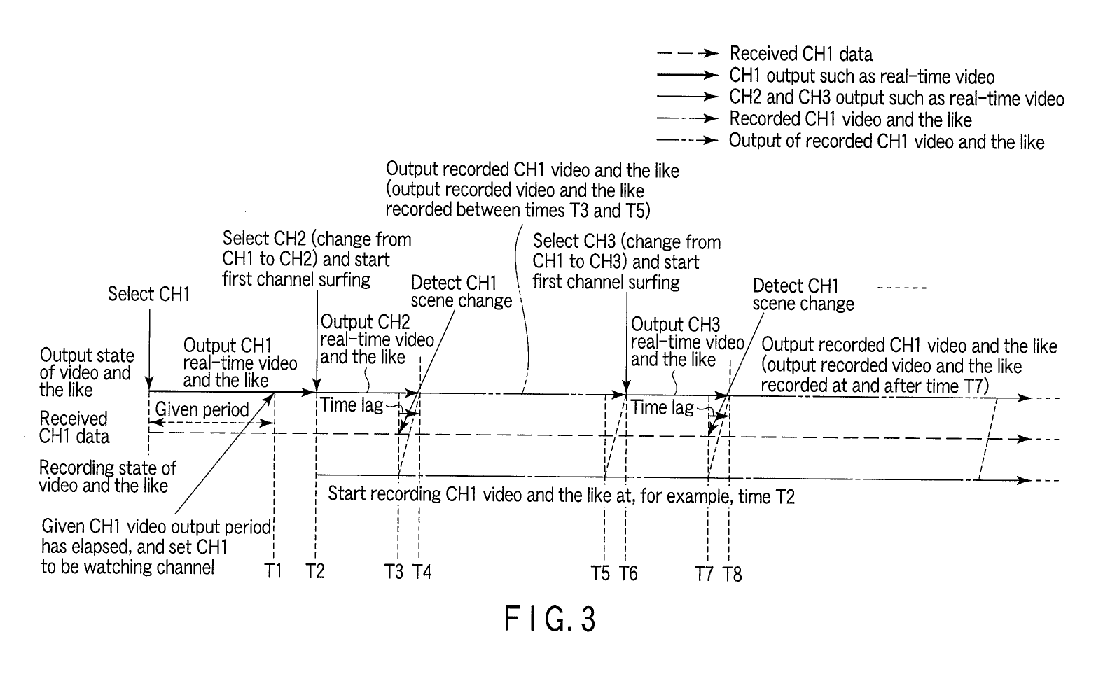

Now, with reference to a flowchart shown in FIG, and timing charts shown in FIG. 3 to FIG. 5, description will be given of examples of first recording and reproduction control to third recording and reproduction control performed by the digital television broadcast receiving apparatus.

### First Embodiment

FIG. 3 is a timing chart showing an example of the first recording and reproduction control. In a first embodiment, a case is assumed in which while watching a desired channel, a user interrupts watching the desired target and selects and temporarily watches one or more different channels as required (the case is what is called channel surfing). In such a case, the digital television broadcast receiving apparatus can perform the first recording and reproduction control described below to prevent a predetermined scene (an important scene or the like) of the desired channel from being missed.

For example, when the user selects a channel (CH1) of the terrestrial digital television broadcasting via the remote controller 17 or the like (BLOCK1), the control module 65 executes control to output first content data (video, audio, and the like) corresponding to the channel 1 (BLOCK2). In response, the video display 14 displays the video corresponding to the first content data, and the speaker 15 outputs audio corresponding to the first content data (BLOCK2).

For example, the control module 65 automatically detects the watching state (for example, whether or not channel 1 is being watched) of the channel 1 in accordance with the period during which the first content data corresponding to the channel 1 is output. Upon determining that the channel 1 is being watched, that is, upon determining the channel 1 to be a watching channel (BLOCK3, YES), the control module 65 sets the channel 1 to be a watching channel (BLOCK4). For example, when the output period of the first content data corresponding to the channel 1 exceeds a given period (for example, 30 seconds, 1 minute, 3 minutes, or minutes), the control module 65 sets the channel 1 to be a watching channel (BLOCK4). For example the control module 65 sets the channel 1 to be a watching channel at time T1 shown in FIG. 3.

Alternatively, the control module 65 can detect the watching state (for example, whether or not the channel 1 is being watched) of the channel 1, in response to the user's operation input. For example, the remote controller 17 comprises a channel key CH1 used to select the channel CH1. For example, when the user depresses and holds the channel key CH1, the control module 65 determines that the channel 1 is being watched, in response to the user's operation input. That is, the control module 65 determines the channel 1 to be a watching channel (BLOCK3, YES). The control module 65 sets the channel 1 to be a watching channel (BLOCK4).

Alternatively, the control module 65 may reference an electronic program guide (EPG) contained in the broadcast signal or the like to detect the user's preference based on a channel selection state, thus detecting the watching state of the channel 1 (for example, whether or not the channel 1 is being watched). The electronic program guidance contains genre information on each of the programs on each channel. Hence, the control module 65 can detect the genre of program that the user watches, in accordance with the selection of a predetermined channel (that is, the selection of a predetermined program) in a predetermined hour. The control module 65 accumulates watching time information for each genre to detect the user's preference. For example, when the control module 65 detects that the user frequently watches sports programs and if the program being broadcast on the selected channel 1 is a sports program, the control program determines that the channel 1 is being watched. That is, the control module 65 determines the channel 1 to be a watching channel (BLOCK3, YES). The control module 65 sets the channel 1 to be a watching channel (BLOCK4).

As described above, when with the watching channel set (this state corresponds to the one observed at and after time T1 shown in FIG. 3), the user further selects the channel 2 (CH2) of the terrestrial digital television broadcasting (BLOCK5, YES), the control module 65 executes control to output second content data (video, audio, and the like) corresponding to the channel 2 instead of the first content data (BLOCK6) (time T2 in FIG. 3). That is, in response to the channel change operation, the video display 14 displays a video corresponding to the second content data, and the speaker 15 outputs audio corresponding to the second content data (BLOCK6).

Moreover, the control module 65 executes control to record the first content data corresponding to the channel 1 in accordance with the result of detection of the watching state and the selection of the channel 2 (change operation) (BLOCK7). For example, upon detecting a change from the channel 1 to the channel 2 (BLOCK5, YES), the control module 65 executes control to start recording of the first content data corresponding to the channel 1 at the channel change time (time T2 in FIG. 3) and to continue the recording of the first content data (BLOCK7). Alternatively, the control module 65 may executes control to start recording of the first content data corresponding to the channel 1 at the set time (time T1 in FIG. 3) for the watching channel and to continue the recording of the first content data (BLOCK7). Thus, the built-in HDD 101, USB-HDD 102, NAS 103, or i.Link-HDD 104 (hereinafter referred to as a program recording section) starts and continues recording the first content data (BLOCK7).

The control module 65 acquires first metadata corresponding to the channel 1 and the first content data corresponding to the channel 1 to monitor changes in the scene of the channel 1. For example, in response to detection of a change in the scene of the channel 1 (BLOCK8), the control module 65 determines that watching is to be resumed (the output is to return to the channel 1) (BLOCK9, YES).

For example, the control module 65 analyzes the audio signal contained in the first content data corresponding to the channel 1 to detect a change in audio signal and thus a change in scene (BLOCK8) (time T3 in FIG. 3). The control module 65 determines that watching is to be resumed (the output is to return to the channel 1) in response to the detection of the change in scene (BLOCK9, YES). Alternatively, the control module 65 analyzes the video signal contained in the first content data corresponding to the channel 1 to detect a change in video signal and thus a change in scene (BLOCK8) (time T3 in FIG. 3). The control module 65 determines that watching is to be resumed (the output is to return to the channel 1) in response to the detection of the change in scene (BLOCK9, YES). The control block 65 may detect a change in scene based on the results of analysis of the audio and video signals.

Upon determining that watching is to be resumed (BLOCK9, YES), the control module 65 executes control to output first recorded content data recorded in the program recording section instead of the second content data (BLOCK10) (time T4 in FIG. 3). For example, the control module 65 executes control to output the first recorded content data recorded at and after time T2 (BLOCK 10). Alternatively, the control module 65 executes control to the first recorded content data recorded at and after time T3 to be output (BLOCK10). In response, the video display 14 displays a video corresponding to the first recorded content data, and the speaker 15 outputs audio corresponding to the first recorded content data (BLOCK10).

If the first recorded content data recorded at and after time T2 is output, then given that a scene change occurs, the user can start watching the program with the scene displayed before the change. Furthermore, if the first recorded content data recorded at and after time T3 is output, then the user can start watching the program with the scene displayed immediately before the change.

A time lag may occur after a change in the scene of the channel 1 is detected (at time T3 in FIG. 3) and before the first recorded content data corresponding to the channel 1 is output (at time T4 in FIG. 3). The digital television broadcast receiving apparatus can still prevent a predetermined scene displayed immediately after the detection of the scene change from being missed. This is because the digital television broadcast receiving apparatus has started recording the first content data corresponding to the channel 1 at time T2 (or T1) shown in FIG. 3 as described above.

When for example, the second content data corresponding to the channel 2 has been output for longer than a given period since the detection of the change to the channel 2 (BLOCK5, YES), the control module 65 determines the channel 2 to be a watching channel and newly sets the channel 2 to be a watching channel (excludes the channel 1 from the watching channel), and removes the first recorded content data recorded in the program recording section. Moreover, when the user 3 then selects a channel 3 (a channel other than the channel 2) of the terrestrial digital television broadcasting via the remote controller 17 or the like, the control module 65 executes control to output third content data (video, audio, and the like) corresponding to the channel 3 instead of the second content data. The control module 65 further executes control to record the second content data corresponding to the channel 2. Alternatively, the control module 65 executes control to record the second content data corresponding to the channel 2 at the setting time for the watching channel.

As described above, when with the video and audio corresponding to the first recorded content data output (this state corresponds to the one observed between times T4 and T6 shown in FIG. 3), for example, the user further selects the channel 3 (the channel other than the channel 1) of the terrestrial digital television broadcasting via the remote controller 17 or the like at time T6 shown in FIG. 3, the control module 65 executes control to stop the output of the first recorded content data (at time T5 in FIG. 3). The control module 65 further executes control to output the third content data (video, audio, and the like) corresponding to the channel 3 instead of the first recorded content data. Although the output of the first recorded content data is stopped, the recording of the first content data continues.

Thereafter, for example, upon detecting a change in the scene of the channel 1 again at time T7 shown in FIG. 3, the control module 65 determines that watching is to be resumed, and executes control to output the first recorded content data instead of the third content data (at time T8 in FIG. 3). For example, the control module 65 executes control to output the first recorded content data recorded at and after time T7 to be output. Alternatively, the control module 65 may execute control to output the first recorded content data recorded at and after time T5.

Subsequently, the output of various types of guide information will be described. As described above, upon determining that watching is to be resumed, the control module 65 may output any of the various types of guide information to control the next operation in response to the user's operation input.

For example, upon determining that watching is to be resumed, the control module 65 executes control to display “Return to Channel 1 (YES/NO)”. If “YES” is selected by the user's operation input, the control module 65 executes control to output the first recorded content data recorded in the program recording section instead of the second content data corresponding to the channel 2. If “NO” is selected by the user's operation input, the control module 65 continues outputting the second content data corresponding to the channel 2.

Alternatively, if “NO” is selected by the user's operation input, the control module 65 re-sets the channel 2 to be a watching channel (excludes the channel 1 from the watching channel). The control module 65 continues outputting the second content data corresponding to the channel 2. Moreover, upon detecting a channel change from the channel 2 to the channel 3 (the channel other than the channel 2), the control module 65 executes control to output the third content data corresponding to the channel 3 instead of the second content data. Moreover, the control module 65 executes control to start recording of the second content data and to continue the recording of the second content data. Alternatively, the control module 65 executes control to start recording of the second content data corresponding to the channel 2 and to continue the recording of the second content data.

Alternatively, upon determining that watching is to be resumed, the control module 65 executes control to display “Record Watching Channel and Return to Channel 1 (YES/NO)”. If “YES” is selected by the user's operation input, the control module 65 executes control to start recording of the second content data corresponding to the channel 2. The control module 65 further executes control to output the first recorded content data recorded in the program recording section instead of the second content data corresponding to the channel 2. That is, with the recording of the first content data continued, the recording of the second content data is started. If “NO” is selected by the user's operation input, the control module 65 continues outputting the second content data corresponding to the channel 2.

As described above, according to the first recording and reproduction control, even if, with the desired channel (channel 1) set to be a watching channel, the user selects and temporarily watches one or more different channels (even if the user is carrying out channel surfing), the output is switched to the video and audio of the desired channel in response to detection of a change in the scene of the desired channel. Thus, a predetermined scene (an important scene or the like) of the desired channel can be prevented from being missed.

### Second Embodiment

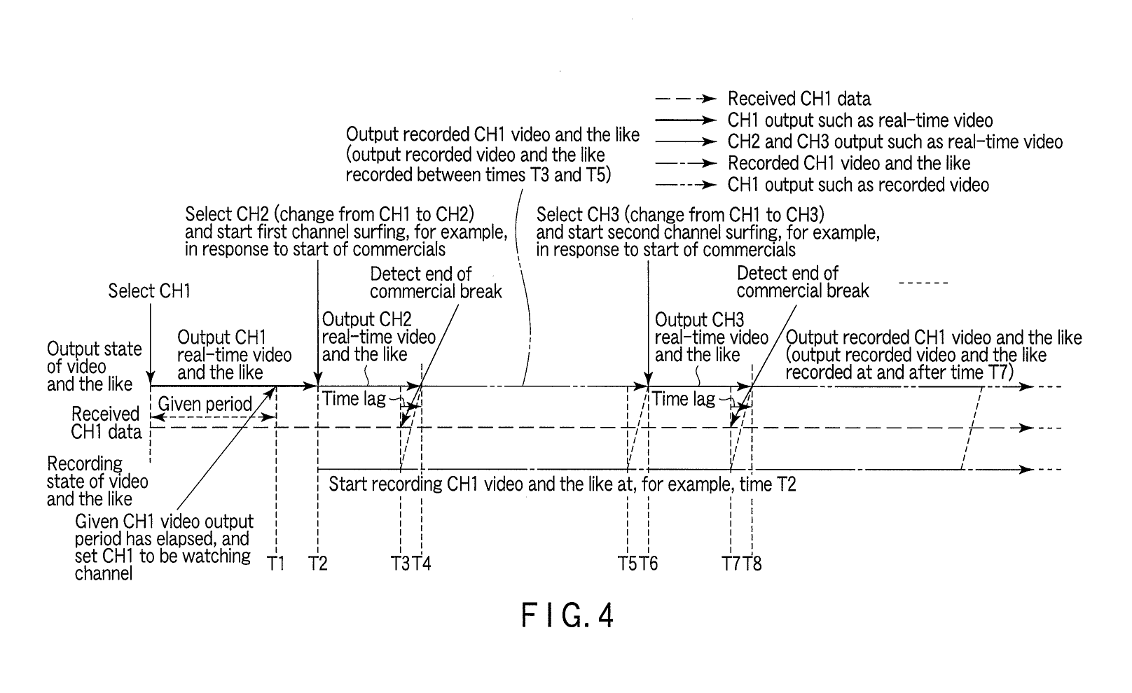

FIG. 4 is a timing chart showing an example of second recording and reproduction control. In the second embodiment, a case is assumed in which while the user is watching the desired channel, commercials are broadcast and in which the user interrupts watching the desired channel and selects and temporarily watches one or more different channels as required (the case is what is called channel surfing). In such a case, the digital television broadcast receiving apparatus can perform second recording and reproduction control described below to prevent a predetermined scene of the desired channel from being missed after the end of commercials.

For example, when the user selects the channel 1 of the terrestrial digital television broadcasting via the remote controller 17 or the like (BLOCK1), the control module 65 executes control to output the first content data corresponding to the channel 1 (BLOCK2). Upon determining the channel 1 to be a watching channel (BLOCK3, YES), the control module 65 sets the channel 1 to be a watching channel (BLOCK4). For example, the control module 65 sets the channel 1 to be a watching channel at time T1 shown in FIG. 4.

When, with the watching channel set (this state corresponds to the one observed at and after time T1 shown in FIG. 4) as described above, commercials are broadcast on the channel 1, for example, the user expects to temporarily watch one or more different channels during the commercials. When the user thus selects the channel 2 of the terrestrial digital television broadcasting (BLOCK5, YES), the control module 65 executes control to output the second content data corresponding to the channel 2 instead of the first content data (BLOCK6) (time T2 in FIG. 4).

Moreover, the control module 65 executes control to record the first content data corresponding to the channel 1 in accordance with the result of detection of the watching state and the selection of the channel 2 (BLOCK7). For example, upon detecting a change from the channel 1 to the channel 2 (BLOCK5, YES), the control module 65 executes control to start recording of the first content data corresponding to the channel 1 at the channel change time (time T2 in FIG. 4) and to continue the recording the first content data (BLOCK7). Alternatively, the control module 65 may execute control to start recording of the first content data corresponding to the channel 1 at the set time (time T1 in FIG. 4) for the watching channel and to continue the recording the first content data. Thus, the program recording section starts and continues the recording the first content data (BLOCK7).

The control module 65 acquires first metadata corresponding to the channel 1 and the first content data corresponding to the channel 1 to monitor the state of the channel 1. For example, in response to detection of a change in the scene of the channel 1 (BLOCK8), the control module 65 determines that watching is to be resumed (the output is to return to the channel 1) (BLOCK9, YES).

For example, the control module 65 analyzes the audio signal contained in the first content data corresponding to the channel 1 to detect a change in audio signal and thus a change in scene (the end of the commercial break) (BLOCK8) (time T3 in FIG. 4). The control module 65 determines that watching is to be resumed (the output is to return to the channel 1) in response to the detection of the change in scene (BLOCK9, YES). Alternatively, the control module 65 analyzes the video signal contained in the first content data corresponding to the channel 1 to detect a change in video signal and thus a change in scene (the end of the commercial break) (BLOCK8) (time T3 in FIG. 4). The control module 65 determines that watching is to be resumed (the output is to return to the channel 1) in response to the detection of the change in scene (BLOCK9, YES).

Upon determining that watching is to be resumed (BLOCK9, YES), the control module 65 executes control to output first recorded content data recorded in the program recording section instead of the second content data (BLOCK10). For example, upon detecting the end of the commercial break on the channel 1 (BLOCK8) (BLOCK9, YES), the control module 65 executes control to output the first recorded content data recorded at and after time T3 instead of the second data (BLOCK 10).

A time lag may occur after a change in the scene of the channel 1 is detected (at time T3 in FIG. 4) and before the first recorded content data corresponding to the channel 1 is output (at time T4 in FIG. 4). The digital television broadcast receiving apparatus can still prevent a predetermined scene displayed immediately after the detection of the end of the commercial break from being missed. This is because the digital television broadcast receiving apparatus has started recording the first content data corresponding to the channel 1 at time T2 (or T1) shown in FIG. 4 as described above.

When for example, the second content data corresponding to the channel 2 has been output for longer than a given period since the detection of the change to the channel 2 (BLOCK5), the control module 65 determines the channel 2 to be a watching channel and newly sets the channel 2 to be a watching channel (excludes the channel 1 from the watching channel), and removes the first recorded content data recorded in the program recording section.

As described above, when with the video and audio corresponding to the first recorded content data output (this state corresponds to the one observed between times T4 and T6 shown in FIG. 4), for example, the user further selects the channel 3 (the channel other than the channel 1) of the terrestrial digital television broadcasting via the remote controller 17 or the like at time T6 shown in FIG. 3, the control module 65 executes control to stop the output of the first recorded content data (at time T5 in FIG. 4). The control module 65 further executes control to output the third content data (video, audio, and the like) corresponding to the channel 3 instead of the first recorded content data. Although the output of the first recorded content data is stopped, the recording of the first content data continues.

Thereafter, for example, upon detecting the end of the commercial break again at time T7 shown in FIG. 4, the control module 65 determines that watching is to be resumed, and executes control to output the first recorded content data instead of the third content data. For example, the control module 65 executes control to output the first recorded content data recorded at and after time T7.

As described in the first embodiment, upon determining that watching is to be resumed, the control module 65 may control the next operation in response to the user's operation input.

As described above, according to the second recording and reproduction control, even if, with the desired channel (channel 1) set to be a watching channel, the user selects and temporarily watches one or more different channels (even if the user is carrying out channel surfing), the output is switched to the video and audio of the desired channel in response to detection of a change in the scene of the desired channel (detection of the end of the commercial break). Thus, a predetermined scene (an important scene or the like) of the desired channel displayed after the end of commercials can be prevented from being missed.

### Third Embodiment

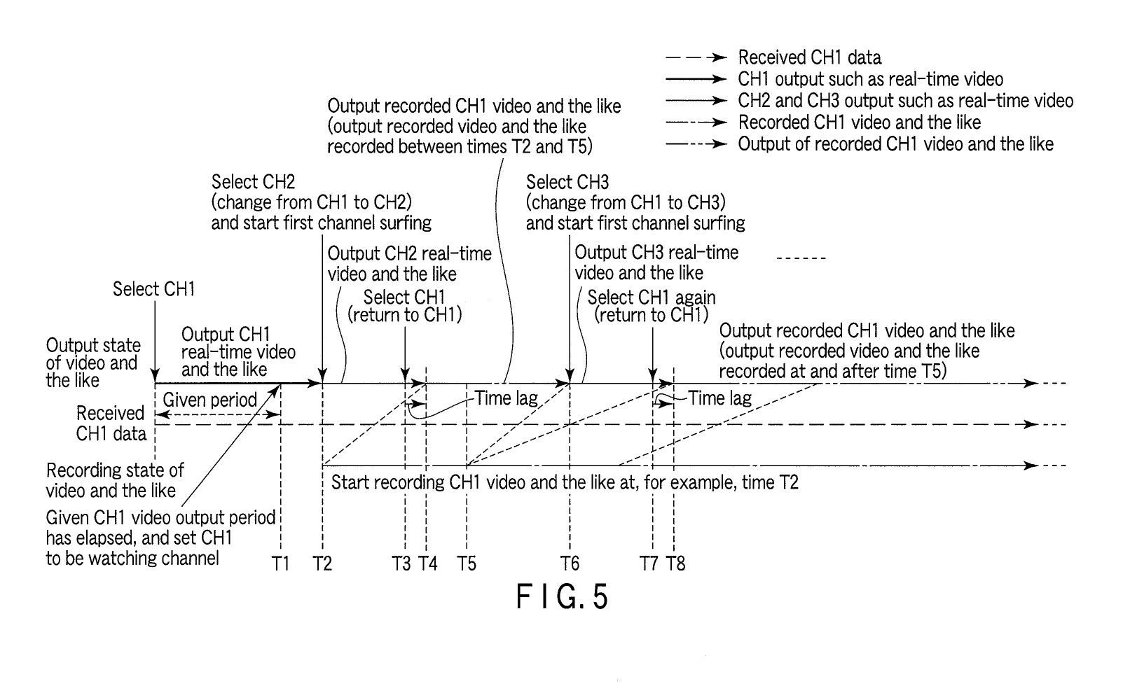

FIG. 5 is a timing chart showing an example of third recording and reproduction control. In the third embodiment, a case is assumed in which while watching the desired channel, the user interrupts watching the desired channel and selects and temporarily watches one or more different channels as required (the case is what is called channel surfing). In such a case, the digital television broadcast receiving apparatus can perform third recording and reproduction control described below to prevent a predetermined scene of the desired channel from being missed.

For example, when the user selects the channel 1 of the terrestrial digital television broadcasting via the remote controller 17 or the like, the control module 65 executes control to output the first content data corresponding to the channel 1. Upon determining the channel 1 to be a watching channel, the control module 65 sets the channel 1 to be a watching channel. For example, the control module 65 sets the channel 1 to be a watching channel at time T1 shown in FIG. 5.

With the watching channel set (this state corresponds to the one observed at and after time T1 shown in FIG. 5) as described above, for example, the user expects to temporarily watch one or more different channels during the commercials. For example, when the user selects the channel 2 of the terrestrial digital television broadcasting via the remote controller 17 or the like, the control module 65 executes control to output the second content data corresponding to the channel 2 instead of the first content data (at time T2 in FIG. 5).

Moreover, the control module 65 executes control to record the first content data corresponding to the channel 1 in accordance with the result of detection of the watching state and the selection of the channel 2. That is, upon detecting a change from the channel 1 to the channel 2, the control module 65 executes control to start recording of the first content data corresponding to the channel 1 at the channel change time (time T2 in FIG. 5) and to continue the recording of the first content data. Alternatively, the control module 65 may executes control to start recording of the first content data corresponding to the channel 1 at the set time (time T1 in FIG. 5) for the watching channel and to continue the recording of the first content data. Thus, the program recording section starts and continues the recording the first content data.

When, with the channel 1 set to be a watching channel and the channel 2 selected as described above (this state corresponds to the one observed between times T2 and T3 shown in FIG. 5), the user further selects the channel 1 via the remote controller 17 or the like (at time T3 in FIG. 5), the control module 65 determines that watching is to be resumed. That is, upon detecting a return to the watching channel (channel 1), the control module 65 determines that watching is to be resumed (the output is to be returned to the channel 1).

Upon determining that watching is to be resumed, the control module 65 executes control to output the first recorded content data recorded in the program recording section instead of the second content data (time T4 in FIG. 5). For example, the control module 65 executes control to output the first recorded content data recorded at and after time T2 (BLOCK 10).

Moreover, when the user further selects the channel 3 (the channel other than the channel 1) of the terrestrial digital television broadcasting via the remote controller 17 or the like at time T6 shown in FIG. 3, the control module 65 executes control to stop the output of the first recorded content data (at time T5 in FIG. 5). The control module 65 further executes control to output the third content data corresponding to the channel 3 instead of the first recorded content data. Although the output of the first recorded content data is stopped, the recording of the first content data continues.

Thereafter, for example, when the user selects the channel 1 via the remote controller 17 or the like at time T7 shown in FIG. 5, the control module 65 determines that watching is to be resumed. Upon determining that watching is to be resumed, the control module 65 executes control to output the first recorded content data instead of the third content data (at time T8 in FIG. 5). For example, the control module 65 executes control to output the first recorded content data recorded at and after time T5.

As described in the first embodiment, upon determining that watching is to be resumed, the control module 65 may control the next operation in response to the user's operation input.

As described above, according to the third recording and reproduction control, even if, with the desired channel (channel 1) set to be a watching channel, the user selects and temporarily watches one or more different channels (even if the user is carrying out channel surfing), the output is switched to the non-watched portion of the video and audio of the desired channel in response to the operation of returning to the desired channel. Thus, a predetermined scene (an important scene or the like) of the desired channel can be prevented from being missed.

Furthermore, in the above-described digital television broadcast receiving apparatus, while the desired channel (channel 1) set to be a watching channel is not being watched, the content data corresponding to the desired channel continues to be recorded. Thus, the user can reproduce previously recorded content data corresponding to the desired channel or reproduce the content data at fast speed starting from a position corresponding to a certain past point in time, as required.

The various modules of the embodiments described herein can be implemented as software applications, hardware and/or software modules, or components on one or more computers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recording control apparatus comprising:
an output controller configured to cause output of first content data corresponding to a first channel in response to selection of the first channel and to cause output of second content data corresponding to a second channel instead of the first content data in response to a channel change from the first channel to the second channel;
a watching state detector configured to detect a watching state of the first channel; and
a recording controller configured to control recording of the first content data based on the watching state and the channel change.

2. The apparatus of claim 1, further comprising:
a scene change detector configured to detect a change in scene based on the first content data during recording of the first content data; and
a reproduction controller configured to control reproduction of recorded content data recorded under control of the recording controller in response to the detection of the scene change and to cause output of the recorded content data instead of the second content data.

3. The apparatus of claim 2, wherein the scene change detector is further configured to detect an end of a commercial break based on the detection of the scene change during the recording of the first content data; and
wherein the reproduction controller is further configured to control reproduction of the recorded content data in response to the detection of the end of the commercial break and to cause output of the recorded content data instead of the second content data.

4. The apparatus of claim 3, wherein the reproduction controller is further configured to control reproduction of the recorded content data from the end of the commercial break in the recorded content data and to cause output of the reproduced content data instead of the second content data in response to the detection of the end of the commercial break.

5. The apparatus of claim 2, wherein the output controller is further configured to stop the output of the recorded content data in response to selection of a third channel during output of the recorded content data and to cause output of third content data corresponding to the third channel; and
wherein the reproduction controller is configured to resume reproduction of the recorded content data in response to detection of the scene change during the stop of the output of the recorded content data and to cause output of the recorded content data instead of the second content data.

6. The apparatus of claim 1, further comprising a reproduction controller configured to control reproduction of the recorded content data recorded under control of the recording controller in response to the channel change from the second channel to the first channel and to cause output of the recorded content data instead of the second content data.

7. The apparatus of claim 6, wherein the output controller is further configured to stop the output of the recorded content data in response to the selection of the second channel during the output of the recorded content data and to cause output of the second content data corresponding to the second channel; and
wherein the reproduction controller is further configured to resume reproduction of the recorded content data starting from an output stop position of the recorded content data and to cause output of the recorded content data starting from the output stop position in response to the channel change from the second channel to the first channel during the stop of the output of the recorded content data.

8. The apparatus of claim 2, wherein the reproduction controller is further configured to:
cause output of a confirmation request in response to the detection of the scene change, wherein the confirmation request is associated with outputting the recorded content data;
control reproduction of the recorded content data in response to receiving confirmation to cause output of the recorded content data; and
cause output of the recorded content data instead of the second content data.

9. The apparatus of claim 8, wherein the output controller is further configured to continue causing output of the second content data in response to an indication to not output the recorded content data; and
wherein the recording controller is further configured to stop the recording of the first content data and to record the second content data in response to an indication to not output the recorded content data.

10. The apparatus of claim 2, further comprising a display configured to display at least one of the first content data, the second content data, and the recorded content data.

11. A recording control method comprising:
outputting first content data corresponding to a first channel in response to selection of the first channel;
detecting a watching state of the first channel;
outputting second content data corresponding to a second channel instead of the first content data in response to a channel change from the first channel to the second channel; and
recording the first content data based on the watching state and the channel change.
